(19) United States
(12) Patent Application Publication
(10) Pub. No.: US 2010/0185701 A1
(43) Pub. Date: Jul. 22, 2010

(54) METHOD AND SYSTEM FOR ENABLING LIFE CYCLE MAINTENANCE OF HIERARCHICAL DATABASE SCHEMAS IN MODELING TOOL

(76) Inventors: Subramaniam Ramamurthi, Rancho Santa Margarita, CA (US); Vikki Mei-Whey Lai, Orange, CA (US); Jennifer Erin Kays, Mission Viejo, CA (US); Minh-Nguyet Thi Tran, Cypress, CA (US)

Correspondence Address: ALFRED W. KOZAK;UNISYS CORPORATION, 25725 JERONIMO ROAD, MS400, MISSION VIEJO, CA, 92691, US

(21) Appl. No.: 12/694,680

(22) Filed: Jan. 27, 2010

Related U.S. Application Data
(62) Division of application No. 11/904,469, filed on Sep. 27, 2007.

(51) Int. Cl. G06F 17/30

(52) U.S. Cl. 707/803; 707/E17.005

(57) ABSTRACT

A Database Operations Center where the schemas in a Metastore Database are converted to the correlating relational schemas that can be represented in Modeling Tools for easy visibility and editing.

### CROSS REFERENCES TO RELATED APPLICATIONS

This application is a divisional of “Method for Enabling Life Cycle Maintenance of Hierarchical Database Schemas in Modeling Tool”, Ser. No. 11/904,469 (Attorney Docket No. MV 0703) filed on Sep. 27, 2007; and related to the following patent applications: “Multi-Processor System for Database Management”, Ser. No. 10/322,535 (Attorney Docket No. 041-441-L), filed on May 28, 1999, issued as U.S. Pat. No. 6,351,744 B1 on Feb. 26, 2002; Ser. No. 11/542,778 (Attorney Docket No. 05-028A) filed on Oct. 4, 2006, “Method And System For Converting Relational Database Schemas To Hierarchical Database Schemas”; Ser. No. 11/796,014 (Attorney Docket No. MV0702.US), filed on Apr. 26, 2007, “Method and System for Converting Hierarchical Database Schemas into Relational Database Schemas”, all are incorporated herein by reference.

### BACKGROUND OF THE INVENTION

A Database Management System consists of a set of tools used to develop and manage a database. The presently described system utilizes DMSII, which is a Database Management System available on a Unisys Corporation's ClearPath HMP NX, and also the Unisys A-Series systems. A background for the Unisys DMSII systems is available in a publication of the Unisys Corporation, Document 8807 6625 000, entitled “Getting Started With DMSII” and published in September 1997 by the Unisys Corporation. The DMSII Utilities provide database backup and recovery capability for the entire database or for partial databases. The background operations of the DMSII utility enhancements are published in a Unisys Corporation publication Document 98037/4 and entitled “DMSII Utility Enhancements” as published on Mar. 31, 1999.

Database Management Systems are used by many large and small businesses such as airline reservation systems, financial institutions, retail chains, insurance companies, utility companies and government agencies. The present Database Management System (DMS) in its form designated as DMSII is used to build database structures for items of data according to some appropriate logical model, such as relational, hierarchical, or network. Further, the Database Management System is used to manage the database structures and keep the structures in some other stable order while various application programs may be retrieving or changing the data. The present embodiment of DMSII has a Data Definition Language designated as Data And Structure Definition Language (DASDL).

There are various tasks that are performed in database management and these involve (i) monitoring and optimizing database performance; (ii) the use of database control for monitoring multi-program database access; (iii) the function of the data integrity and safety done by integrity checking and preventing access to the same data by multiple applications occurring at the same time; (iv) the function of defining data structures and the data fields within them, including the function of modifying data structures; (v) data access operations and developing an application program to retrieve data or to change data; (vi) the function of data shareability to provide multi-program access without conflicts and provide database definitions to the application program; (vii) in database and data security, to prevent unauthorized database access; (viii) ensuring independence of application programs from certain data changes and preventing the revision of application programs every time a structure changes; (ix) in database and data recovery, performing the resumption of database operations after an interruption; (x) tracking data changes by keeping a record of every change made to the data; (xi) for data change integrity, ensuring that update changes are applied to, or removed from, the database in their entirety; (xii) providing a recent copy of the database as a reserve by backing-up the database and storing copies of audit files and all other database files; (xiii) providing for database scalability by growing or shrinking the database according to the ongoing needs at the time.

The DMSII provides standard software files that perform services and operations for all the databases connected to the system's Enterprise Server. This enables a viewing of a list of all these files on the user terminal.

A Database Administrator (DBA) is used to keep the database running smoothly and to enforce the rules for data integrity and security.

In environments where Unisys ClearPath servers are used, systems from several other hardware and software vendors may be found. Many of the business databases on these other systems are based on the Relational Database Model. The need for database administrators (DBA) to leverage their time as efficiently as possible has led the database industry to provide some ease-of-use features to their products. For example, a DMSII Database Operations Center (DOC) provides a graphical user interface (GUI) for the Enterprise Database Server in its Extended Edition.

It has been found that there is a need for tooling to enable the visualization and editing of the mainframe database schemas in Relational Modeling Tools which are applicable to the Unisys Mainframe Enterprise Server Database (DMSII)

### FIELD OF THE INVENTION

A Database Operations Center (DOC) provides a Server having a database providing a platform for mission critical applications where a schema (XMI Format) is used to populate a modeling tool to allow viewable and editable information for schemas.

### SUMMARY OF THE INVENTION

A Database Operations center (DOC) is provided with a database administration tool which operates to enhance the functionality of a multiple platform server.

A schema in the server database is set in an XMI format and then used to populate a Modeling Tool. The Modeling Tool has an Attachment Feature which is used to add hierarchical database artifacts into the Modeling Tool.

This permits a user to view schema information and to edit schema information. Then processors are used to map and organize this schema information into the modeling tool's visual representation. After this, edited information can be transferred back into the XMI file where this XMI file carries the edited information to enable a round-trip life cycle of schema.

A server environment can deploy a database schema that is usable by application programs. Then from time-to-time these database schemas will undergo changes which are effected into the schema. As a result, the database is redeployed to reflect the changed database. The operational cycle where changed-schemas in the database are accessed and deployed to indicate the updated database is called a “round trip life cycle” of the schema.

Current methods of viewing and editing DMSII schemas are done in a proprietary format and required a steep learning curve. This invention enables users to visualize the complex database schema of DMSII in modeling tools to graphically view the schemas and then edit them. Users are familiar with industry standard modeling tools to view/edit relational databases and this invention gives them the same flavor of viewing and editing of DMSII databases.

### BRIEF DESCRIPTION OF THE DRAWINGS

FIG. 1 is a drawing showing the process of selecting a schema from a server database in order to develop a Relational Schema Model.

FIG. 2 is a drawing showing the use of a Modeling Tool to visualize the DMSII information.

FIG. 3 is a drawing to indicate how data types are converted to items in a Modeling Tool.

FIG. 4 is a general drawing showing the major elements involved in the process of selecting a schema from Metastore and transferring the schema to the modeling tool.

FIG. 5 is a Table I which shows the Basic Link syntax.

FIG. 6 illustrates the Counted link.

FIG. 7 illustrates the Self-Correcting Links

FIG. 8 illustrates the Symbolic Link.

FIG. 9 illustrates the Unprotected Link.

FIG. 10 illustrates the Verified Link.

FIG. 11 shows a Table II indicating Relational Items for 22b of FIG. 2.

FIG. 12A illustrates the DMSII item 24a of FIG. 2.

FIG. 12B shows the DMSII item 24b of FIG. 2.

FIG. 12C shows the converted item 24c of FIG. 2.

FIG. 13A shows the DMSII item 23a of FIG. 2.

FIG. 13B shows the converted item 23b as a relational schema model.

FIG. 14A shows the DMSII item 27c of FIG. 2.

FIG. 14B shows the converted item 27d as a relational schema model.

FIG. 15A shows the DMSII item ALPHA of FIG. 3A.

FIG. 15B shows the item which is converted to the relational schema model.

FIG. 16A shows the DMSII item REAL of FIG. 3A.

FIG. 16B shows the converted item in the relational schema model.

FIG. 17A shows DMSII item B1 (FIELD) in FIG. 3B.

FIG. 17B shows the converted item in the relational schema model.

FIG. 18A shows the DMSII item B7 in FIG. 3B.

FIG. 18B shows the converted item B8 in the relational schema model.

FIG. 19A shows DMSII item B11 of FIG. 3B.

FIG. 19B shows the converted item as B12 in the relational schema model.

FIG. 20A shows the DMSII item B19 (LINK) of FIG. 3B.

FIG. 20B shows the converted item as B20 in the relational schema model.

FIG. 21A shows the DMSII item B25 of FIG. 3B.

FIG. 21B shows the converted item as B26 in the relational schema model.

### GLOSSARY ITEMS

1. AGGREGATE: In the Enterprise Database Server, a control item that is a count or sum maintained by the Enterprise Database Server that is based on data items in a data set.
2. ALPHA: In the Enterprise Database Server, a data item that contains EBCDIC characters.
3. ATTACHMENT FEATURE OF MODELING TOOL: Attachment—also called User Defined Property (UDP)—a piece of information that you can associate with a diagram object selected such as diagram, table, index and column.
4. AUTO-GENERATED METASTORE: The schema for the DASDL of the METASTORE database is generated from the model. The model is the Common Warehouse Metamodel plus self-design editing commands resident in the XMI input file. This schema is generated by a program which may be a code generator.
5. BLOB: In the Enterprise Database Server, a data item that is used to store a binary large object.
6. CATALOG ELEMENT: A node in a CWM-based XMI document describing a relational Catalog. A Catalog is a collection of schemas. In this case, the Catalog has only one schema. A Relational Catalog is one that contains relational schemas.
7. CHECK-IN SCHEMA: A relational database schema that is exported from a modeling tool as an XMI file and checked into the METASTORE DATABASE.
8. CHECK-IN SCHEMAS WITH VERSION CONTROL: Schemas are persisted in a METASTORE database in its entirety for each version of the schema.
9. CHECK-OUT SCHEMA: A version of a schema in the Metastore which has the check-out status set.
10. CLOB: In the Enterprise Database Server, a data item that is used to store a character large object.
11. CODE GENERATOR: A design-time Visual Basic 6 program that reads the ‘CWM-DMSII’ model and generates the schema for the Metastore database, and for the MSSUPPORT library.
12. COLUMN ELEMENT: A node in a CWM-based XMI document describing a relational database column.
13. COLUMN OF LINK TYPE: A column with Link Type Data.
14. COMMAND STORE UTILITY: Command Store Utility is a Unisys-developed Visual Basic control packaged with the Database Operations Center that provides the capability to save and restore requests during and between Database Operations Center sessions.
15. COMMON WAREHOUSE METAMODEL (CWM): Standard interfaces that can be used to enable easy interchange of warehouse and business intelligence metadata between warehouse tools, warehouse platforms and warehouse metadata repositories in distributed heterogeneous environments. CWM is a dialect of XMI designed specifically for this purpose.
16. CONTROL FILE: The Control File is unique to each database and maintains state information between activations of a database as well as across Halt/Loads.
17. COUNT: In the Enterprise Database Server, a control item that contains a system-maintained count of the number of counted links that refer to the record containing it. The use of a count item allows read-only access to the count field of a record. Any data set referenced by a counted link must contain a count item. Records that contain a nonzero count cannot be deleted.
18. DASDL: Data and Structure Definition Language. The language used to specify the structure and specific software configuration for a database. This is also the abbreviated name for SYSTEM/DASDL, the compiler used to create Enterprise Database Server Description Files from the DASDL source. Described in document entitled “Enterprise Database Server for ClearPath MCP Data and Structure Definition Language (DASDL) Programming Reference Manual”, Form number is 8600 0213-410. Published by Unisys April 2005.
19. DASDL FEATURES: The database features that make up the characteristics of a DMSII database. Some of them relate closely to a relational database model and some of them are unique to the DMSII database.
20. DASDL IMPORT-EXPORT: A feature used to provide the ability to graphically define, modify and create the schemas of DMSII databases and manage their deployment.
21. DASDL SOURCE: The symbol file containing the data and structure definition for an Enterprise Database Server database. The DASDL compiler creates an Enterprise Database Server Description file from this source.
22. DATA SET: A node in a CWM-based XMI document describing a DMSII Data Item. Also called a DMSII Dataset—In the Enterprise Database Server, a collection of related data records stored in a file on a random-access storage device. A dataset is similar to a conventional file. It contains data items and has logical and physical properties similar to files. However, unlike conventional files, datasets can contain other datasets, sets, and subsets. An example is shown below:

a. <CWMXDMSII.DataSet xmi.id=“_7” name=“Employee”
visibility=“public” namespace=“_6” organization=“STANDARD”>
<CWM.Classifier.feature>
<CWMXDMSII.DataItem xmi.id=“_8” name=“employeeNumber” type=
“_9” visibility=“public” isRequired=“true” initialValue=“” length=“10”/>
<CWMXDMSII.DataItem xmi.id=“_10” name=“employee-first-name”
type=“_11” visibility=“public” isRequired=“false” initialValue=“”
length=“30”/>
<CWMXDMSII.DataItem xmi.id=“_12” name=“empoloyee-last-name”
type=“_11” visibility=“public” isRequired=“false” initialValue=“”
length=“30”/>
</CWM.Classifier.feature>
</CWMXDMSII.DataSet>

23. DBA: Database Administrator. A person responsible for managing and maintaining the definitions, accessibility, integrity, security, backup and recovery of the database, and qualifying all changes to database performance.
24. DATABASE ELEMENT: A node in a CWM-based XMI document describing a DMSII database.
25. DATABASE OPERATIONS CENTER (DOC): The software product that enables a user to perform database administration functions and to perform Enterprise Database Server utilities. Database Operations Center (DOC) includes Command Store Utility. DOC-UI is a Document Operations Center-User Interface which is used to request a MSGenerator to generate a DMS XMI file from a schema in a Metastore Database.
26. DATABASE TO MODEL: Converting structures, items, options, and properties in the DMSII schema to known structures, items, options, and properties in the relational schema model.
27. DATA TYPE TO DERIVED TYPE: converting DMSII data types to known data types in the relational schema model.
28. dbaMONITOR: dbaMONITOR™ is a database administrator's tool which can be utilized for controlling and monitoring the Enterprise Database Server (DMSII) database environments. dbaMONITOR works with any database system that is DMSII-based: DMSII, LINC, SIM and SQL Databases.
29. dbaTOOLS: dbaTOOLS™ is a database administrator's tool which can be utilized for controlling and monitoring the Enterprise Database Server (DMSII) database environments. dbaTOOLS works with any database system that is DMSII-based: DMSII, LINC, SIM and SQL Databases.
30. DEPLOY SCHEMA: A version of a schema in the Metastore that is associated with a running database.
31. DEPLOYED DATABASE: An MCP server database that is created from a schema in the Metastore Database.
32. DESCRIPTION FILE: The Description File contains the machine-readable layout of every aspect of a database. A new copy is generated by DASDL for each format level and is used by SYSTEM/DMCONTROL as well as DMINTERFACE in support of the language compilers.
33. DMCONTROL: SYSTEM/DMCONTROL is a database utility program that creates and maintains the Control File.
34. DMINTERFACE: A co-routine used by the language compilers to translate the properties of a database into the record area offsets used by the compiled application program.
35. DMSII: Unisys Data Management System II; The comprehensive, primary database management software package developed by Unisys that is in use on Unisys Series and Clearpath families of mainframe computers.
36. DMSII DATA TYPES: Data types that are designed into DMSII databases. Examples are: ALPHA (character data), NUMBER (numeric data).
37. DMSII MODEL: The CWM DMSII extension package contains classes supporting the description of DMSII database schemata and their deployment. The DMSII extension package is provided as an example demonstrating appropriate usage of CWM classes in modeling this and similar DMS environments.
38. DMSII SCHEMAS (PLURAL): Schemas of several databases in a Server as described by the definition of “Schema information”. Glossary #87.
39. DMSII XMI FILE (CWM-BASED): An XMI document which follows the CWM standard. This document describes a DMSII database.
40. DMSUPPORT: The DMSUPPORT library is unique to each format level of a database. It contains the mappings between the storage layouts used by the database and those used within the application program record areas.
41. EMBARCADERO ER/STUDIO™: This is a third party modeling tool that is used by Unisys to qualify the features of the product. This tool deals with diagramming the schema, manipulation of schema, and transforming schema among various industry standard file formats.
42. EMBARCADERO MODELING TOOL™: ER/Studio. A model-driven data architecture and database design solution.
43. ENTERPRISE DATABASE SERVER: The comprehensive, primary database management software package developed by Unisys that is in use on Unisys Series and ClearPath families of mainframe computers.
44. FIELD: In the Enterprise Database Server, a data item that can contain unsigned integer or Boolean values.
45. FILLER: In the Enterprise Database Server, a data item that reserves space in a data record for future use.
46. FORMATTING OBJECTS (XSL-FO), a language for specifying formatting semantics. See also XSL-FO, XSLT.
47. FTP: File Transfer Protocol. The Internet standard high-level protocol for transferring files from one machine to another over TCP/IP networks.
48. HIERARCHICAL DATABASE ARTIFACTS: The hierarchical database (DMSII) contains features that do not exist in a relational database. Example of such feature is embedded datasets. Embedded datasets are similar to a table containing another table as a column. Such embedding is not permissible for relational database schemas: eg:

### Employee [Table]

### (Name,

### Company [Table]

(Company name,

Company address)

### Salary)

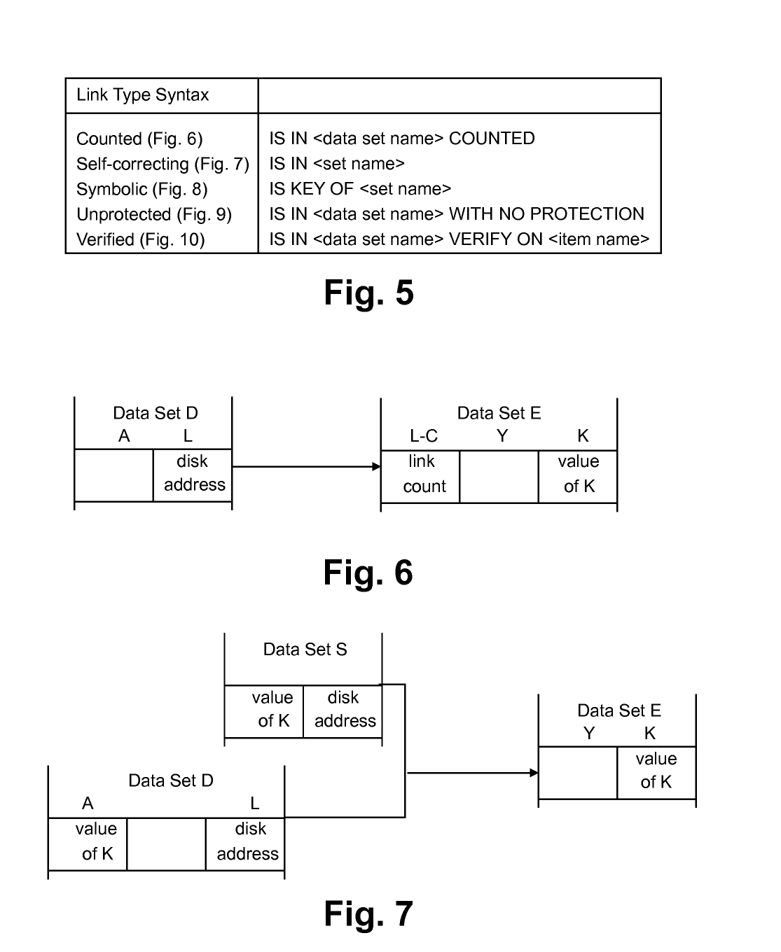

49. LANGUAGE—NEUTRAL INDUSTRY STANDARD: A standard based on function, not an implementation language or interface language.
50. LINK STRUCTURE: In the Enterprise Database Server, a link data item is used to link one data set record to another. Link structures are data set or set that are pointed to by the link items.
51. LINK TYPE: In the Enterprise Database Server, a link data item is used to link one data set record to another. Link types are different types of link items.
   There are five different types of links corresponding to the five mechanisms by which a link can point to a record in a data set. Table I (FIG. 5) provides the basic syntax for each type of link. Following the table is a more detailed explanation of each type of link, as seen in FIGS. 6, 7, 8, 9, 10. Those items are related to the examples for link types. The definitions are as follows:
   (i) Data Set D—a data set named D in a DMSII database
   (ii) “A”—a data item named A in a DMSII database
   (iii) “L”—a link item named L in a DMSII database
   (iv) Data Set E—a data set named E in a DMSII database
   (v) “L-C”—a count data item named L-C in a DMSII database
   (vi) “Y”—a data item named Y in a DMSII database
   (vii) “K”—a data item named K in a DMSII database
   (viii) Set S—a set named S in a DMSII database
   (ix) disk address—an address used to locate data on a random-access data storage device

### Counted Links

A data set referenced by a counted link must contain a count item. The count item is maintained by the system. Its value indicates the number of counted links that currently point at the record. Records which contain a nonzero value in the count item cannot be deleted. Any program which attempts to delete a record with a nonzero count item receives an exception and the record is not deleted. FIG. 6 illustrates a counted link.

### Self-Correcting Links

When a self-correcting link is assigned a value, both the address and the key of the referenced record are stored in the link. On retrieval, the key value stored with the link is compared to the key of the record located using the address. If the key values are not equal, the set is searched using the key value stored in the link item. If the search is successful, the address field in the link item is corrected, otherwise, the user program is notified that no record was found and the link is assigned a null value. If the key value stored with the link and the key in the referenced data set match, self-correcting links provide quick access to the referenced data set. When the values do not match, the system automatically corrects the link to ensure that future references to the link will locate the record directly.
FIG. 7 illustrates self-correcting links.

### Symbolic Links

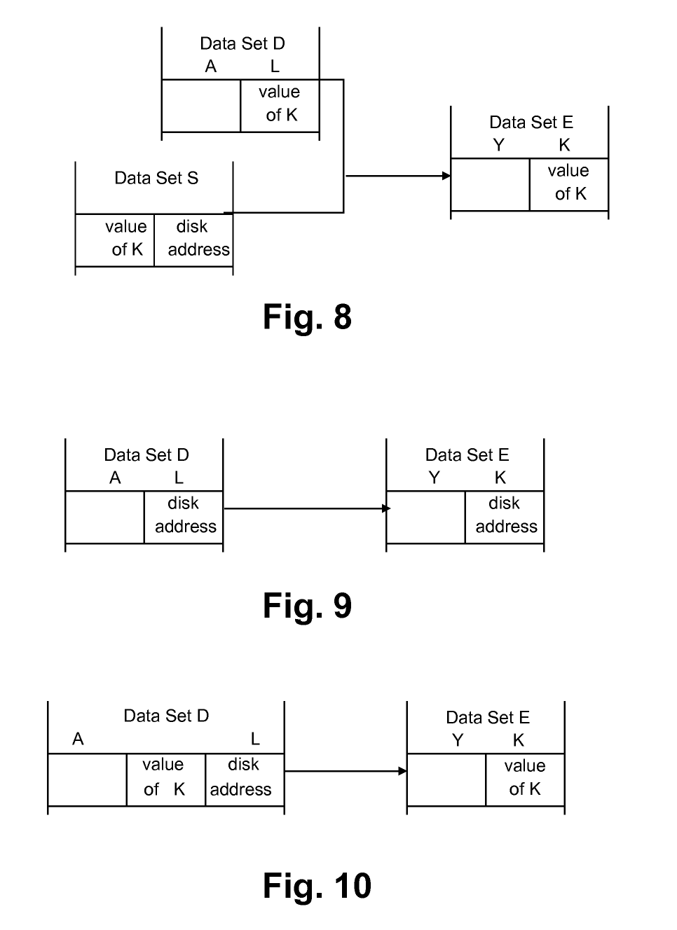

When a symbolic link is assigned a value, the key value of the referenced record is stored in the link. On retrieval, this key value is used to search the set. Records can be changed or deleted without concern for existing links because all accesses go through the set. A NOTFOUND exception is returned when a FIND operation is performed and no matching entry is found in the set.
Symbolic links are most useful when the referenced data set changes frequently.
FIG. 8 illustrates symbolic links.

### Unprotected Links

When an unprotected link is assigned a value, the address of the referenced record is stored in the link. During retrieval this address is used to locate the record. The user is entirely responsible for ensuring that the correct record is retrieved. If the record pointed to by the link is relocated or deleted, results from the use of the link are unpredictable.
Unprotected links should be used only when the records in the data set referenced by the link will never be deleted or moved. In general, unprotected links should be avoided.
FIG. 9 illustrates an unprotected link.

### Verified Links

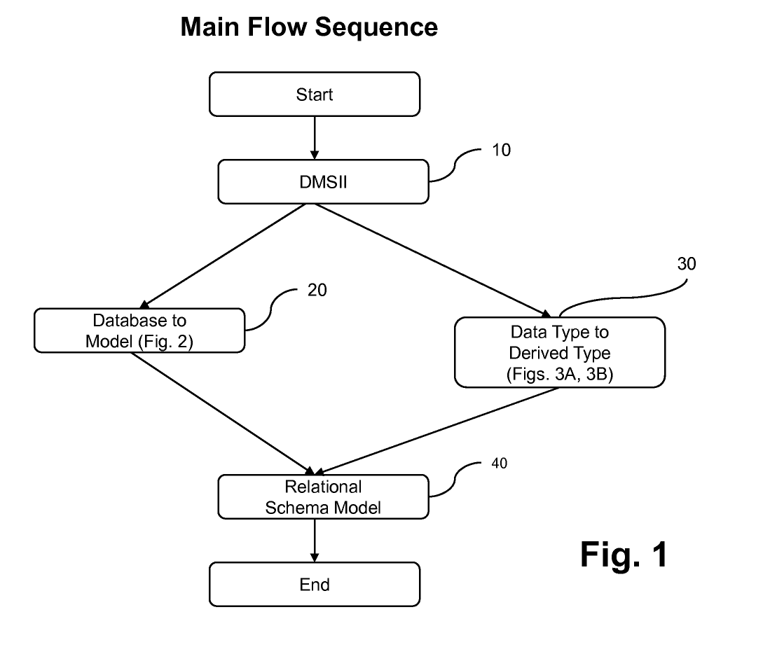

When a verified link is assigned a value, both the address of the referenced record and the value of the item specified following VERIFY ON are stored in the link. On retrieval the value of the item stored with the link is compared to the value of the item in the record located using the address. If the values are not equal, an exception is returned.
FIG. 10 illustrates a verified link.
52. LONGVARCHAR: This is a Structured Query Language (SQL) data type. The LONGVARCHAR type allows storage of character strings with a maximum length of 2³¹−1 (2,147,483647) characters. (2 to the 31^{st} power minus 1)
53. MAINFRAME DATABASE: Also known as DMSII database, Enterprise Database Server. This is the database that runs on Unisys ClearPath Servers.
54. MASTER CONTROL PROGRAM (MCP): The operating system developed by Unisys that is in use on A-Series and ClearPath families of mainframe computers.
55. METASTORE: A DMSII database whose schema is generated from the DMSII extended CWM-based model. This database holds all the schemas of DMSII databases of the system.
56. METASTORE DATABASE SERVER: An Enterprise Database Server is a database server that resides on an MCP Server. It is designed to store database schema information based on the Common Warehouse Meta Model (CWM).
57. MODELING/CODE GENERATION: This is design flow. It is the flow of activities that is used to ‘self design’ the project and automate the code generation based on the model. A flow diagram from Start to End describes the steps taken to model a DMSII schema in a relational modeling tool. (FIG. 1)
58. MODELING TOOL: Third party programs that allow customers to build graphical models for database schemas. These tools enable converting the models into many industry standard formats such as CWM (Common Warehouse Metamodel). Embarcadero's ER/Studio is one such modeling tool with which the invention has been developed around.
59. MODIFIED SCHEMAS: Schemas in the Metastore Database can be updated using the check-out feature by downloading the latest version of the schema and importing the XMI file back into the modeling tool.
60. MSDESCLOADER: The program that reads the description file, packages the schema, and loads it into Metastore database using the methods provided by the MSSUPPORT library.
61. MSOR: Marketing Statement of Requirements.
62. MSGENERATOR: An ALGOL program that extracts a schema from Metastore and generates a DASDL source file and an XMI file (based on the DMSII extended CWM-based model).
63. MSSUPPORT: A machine generated (by the code generator) ALGOL library that exports ‘methods’ for user programs. These methods allow user programs to create records in the Metastore database for storing the schema information. These methods also allow editing, deleting and inquiring of the schema information.
64. MSSUPPORT LIBRARY: A DMALGOL library program generated from the DMSII extended CWM-based model. This internal library serves utility programs and provides functions to access/update/delete schemas residing in the Metastore database.
65. MSUTILITY: A utility program written in ALGOL that provides supportive functions to help the Database Operational Center Server to accomplish user functions of DASDL Import-Export.
66. MSXMILOADER: An ALGOL program that reads the XMI file (based on the DMSII extended CWM-based model) and stores the schema in the Metastore database.
67. PERSISTED MODEL: Model stored in a METASTORE database.
68. POPULATING THE MODELING TOOLS: Importing a schema XMI into a modeling tool so that it can be graphically shown.
69. POPULATION: In the Enterprise Database Server, a control item that contains the number of records in a given data set.
70. PPG: Programmer's Process Guide.
71. PROGRAMMER'S WORKBENCH: Programmer's Workbench (formerly NX/Edit) is a client/server application that integrates the editing and patching capabilities of CANDE and the Editor utility with the familiar graphical interface of the Windows environment. CANDE is the Command and Edit language for ClearPath MCP Servers. It provides generalized file preparation and updating capabilities in an interactive terminal-oriented environment such as NX/View.
72. RDB: See Remote Database Backup.
73. RELATIONAL DATABASE: A database in the form of tables which have rows and columns to show the relationships between items, and in which information can be cross-referenced between two or more tables to generate a third table. A query language is used to search for data. If data is changed in one table, it will be changed in all related tables. A database that has only one table is called a flat file database.
74. RELATIONAL DATABASE SCHEMA: A schema describing a relational database. See definitions for Schema and Relational Database.
75. RELATIONAL MODELING TOOLS: Third party software that allows managing relational databases in terms of diagramming the schema, generating databases, and converting schemas among multiple industry standard file formats.
76. RELATIONAL SCHEMA MODEL: A database schema of a relational database represented by an industry standard modeling XMI format such as Common Warehouse Metamodel.
77. RELATIONAL XMI FILE: An XMI file containing a description of components of a relational database schema.
78. REMOTE DATABASE BACKUP: A disaster recovery capability for DMSII databases that enables the replication of an audited (primary) database on a second Server. The replicated (secondary) database is kept synchronized with the primary database through the application of audits from the primary database. The secondary database can take over the role of the primary database.
79. REORGANIZATION: The process used to change the physical layout of a data structure as well as to add or delete fields.
80. RESTART TYPE: In the Enterprise Data Server, a control item in the Restart Data Set that identifies the value of the Restart record.
81. ROUND TRIP LIFE CYCLE OF SCHEMAS: A database schema can be deployed in a Server environment such that is usable by application programs. Periodically these schemas undergo changes. These changes are effected in the schema and the database is redeployed to reflect the changed database. This process is called a round trip life cycle of schema.
82. RSN: Record Set Number in the Enterprise Database Server, a number that is assigned to each record of a data set defined with the DASDL EXTENDED attribute. The RSN assigned to a record never changes, is unique within the data set and is never reused.
83. SAX: Simple API for XML, originally a Java-only API, SAX was the first widely-adopted API for XML in Java, and is a “de facto” standard.
84. SCC: Software Configuration Control.
85. SCHEMA: A set of rules describing the format of a database.
86. SCHEMA ELEMENT: A node in a CWM-based XMI document describing a relational Schema.
87. SCHEMA INFORMATION: The contents of a database schema that describes the physical and logical characteristics of the database.
88. SERVER: Part of a computer architecture called Client/Server architecture. It is the software running on an individual's PC or a centralized computer system. The server responds to requests from a companion application called a client. For Database Operations Center, the server runs on the ClearPath MCP Server computer.
89. SET ELEMENT: A node in a CWM-based XMI document describing a DMSII Set. Below is an example of a Set element:

<CWMXDMSII.Set xmi.id=“_465665”
name=“ORDERSNUMBER” visibility=“public”
setType=“INDEX SEQUENTIAL” spannedClass=“_465661”
isSorted=“FALSE”>
<CWMXDMSII.Set.keyDataItem>
<CWMXDMSII.DataItem xmi.id=“_10000020”
name=“TITLE” xmi.idref=“_465704”/>
</CWMXDMSII.Set.keyDataItem>
<CWM.Index.indexedFeature>
<CWM.IndexedFeature xmi.id=“_465720” name=“ISBN”
visibility=“public” isAscending=“TRUE” feature=“_465703”
index=“_465665”/>
</CWM.Index.indexedFeature>
<CWM.Namespace.ownedElement>
<CWMXDMSII.DASDLProperty xmi.id=“_10000021”
name=“setType” visibility=“public” owner=“_465665”
text=“INDEX SEQUENTIAL”/>
<CWMXDMSII.DASDLProperty xmi.id=“_465721”
name=“LOADFACTOR” visibility=“public” owner=“_465665”
text=“66”/>
<CWMXDMSII.DASDLProperty xmi.id=“_465722”
name=“BLOCKSIZE” visibility=“public” owner=“_465665”
text=“100 ENTRIES ”/>
<CWMXDMSII.DASDLProperty xmi.id=“_465723”
name=“AREAS” visibility=“public” owner=“_465665”
text=“20”/>
<CWMXDMSII.DASDLProperty xmi.id=“_465724”
name=“AREASIZE” visibility=“public” owner=“_465665”
text=“150 TABLES ”/>
<CWMXDMSII.DASDLProperty xmi.id=“_465725”
name=“CHECKSUM” visibility=“public” owner=“_465665”
text=“TRUE”/>
</CWM.Namespace.ownedElement>
</CWMXDMSII.Set>

90. SPO: Single Point Operations allows one operator to manage multiple heterogeneous computer systems from a single graphical display. Systems can be centrally located or distributed. SPO is a key component for automated, centralized operations of a multi-system environment.
91. SQL INDEX ELEMENT: A node in a CWM-based XMI document describing a relational Index. SQL is Structured Query Language developed by Microsoft.
92. SQL SIMPLE TYPE: A node in a CWM-based XMI document describing a relational data Type.
93. SQL SERVER: A multi-user relational database management system based on ISO standards.
94. SURE: SURE is a system that provides life cycle support for development on Unisys CP/NX Series systems.
95. USER COMMUNICATION FORM: This form is used to record, and track the problems that are occurring in the software.
96. TOOLING—MODELING TOOLS: Industry-wide programming tools that allow creation, manipulation, and processing of database schemas using diagrams in a graphical user interface style. Northwind is a common sample database provided by Microsoft. It is an example of a relational database. “Open Tools” are third party products designed to model relational databases. The user will import their relational schema into one of these products. They can view, modify and save their schema. EMBARCADERO: A modeling tool enabling a user to create an XMI file representation of a relational model database.
97. TRANSACTION COUNT: In the Enterprise Database Server, a control item in the Restart Data Set that contains a count of the number of times the program has been in transaction state.
98. UDP—USER DEFINED PROPERTY: See Attachment Feature of Glossary #3.
99. VDBS: Visible Database Stack. A set of commands that are issued directly to a database stack to interrogate or change some aspect of the database configuration.
100. WFL: Workflow Language. On ClearPath MCP computers, WFL is used for constructing jobs that compile or run programs. WFL is a true programming language with its own compiler that either produces an object code file used in running a job or executes a job interpretively. A WFL job is always recompiled each time it is run.
101. XMI DIALECT: A specific application of XMI to provide for interchange of metadata within a specific usage domain. For example, CWM is an XMI dialect enabling interchange of metadata about data warehouses and related business intelligence systems.
102. XMI FILE (CWM-BASED): An XMI document which follows the CWM standard.
103. XMI BASED: The description of a model using XMI file formats.
104. XMI: XML Metadata Interchange. It is a use of the Extensible Markup Language that is intended to provide a standard way for programmers and other users to exchange information about metadata (essentially, information about what a set of data consists of and how it is organized). Specifically, XMI is intended to help programmers using the Unified Modeling Language (UML) with different languages and development tools to exchange their data models with each other. In addition, XMI can also be used to exchange information about data warehouses, using the CWM XMI dialect. Effectively, the XMI format standardizes how any set of metadata is described and requires users across many industries and operating environments to see data the same way. An XMI file is a special case of an XML file and is thereby subject to all of the well-formedness rules of XML files.
105. XML ATTRIBUTE: Information added to a tag to provide more information about the tag, such as:
   <ingredient quantity=“2”units=“cups”>flour</ingredient>.
106. XML ELEMENT: Information delimited by a start tag and an end tag in an eXtensible Markup Language (XML) document. An example would be <Lastname>Davalio</LastName>.
107. XML: Extensible Markup Language: It is a simple, very flexible text format derived from SGML (ISO 8879). Originally designed to meet the challenges of large-scale electronic publishing. XML is also playing an increasingly important role in the exchange of a wide variety of data on the Web and elsewhere.
108. XML PARSER: A tool used to convert a stream of XML information into a set of structures that an application can use.
109. XML SCHEMA: A specification providing a common base for data description and validation in XML environments. XML schema replaces Document Type Definition (DTD) by defining a greater set of data types with more explicit data descriptions. XML schema has been developed as an open, vendor-neutral format to enhance information exchange and e-commerce over the Internet. It is also a standard for the description and encoding of data.
110. XML STYLESHEET: Contains formatting rules that are applied to an XML file referencing the stylesheet. The standard set of rules for XML stylesheets is the Extensible Stylesheet Language (XSL), see also XSL.
111. XML SYNTAX: A fragment of well-formed XML text.
112. XSDL: Acronym for XML Schema Description Language. A Worldwide Web Consortium (W3c) recommendation for representing XML structure. XSDL is capable of describing complex XML-based data structures, and provides options not available with Document Type Definitions (DTDs), including namespace support, XML data types, and improved extensibility and data type support.
113. XSL: Acronym for Extensible Stylesheet Language. A Worldwide Web Consortium (W3C) standard stylesheet language for XML documents. XSL determines how data in an XML document is displayed on the Web. XSL controls what data will be displayed, in what format, and in what type size and style. XSL contains two major extensions: XSL Transformations (XSLT), a language used to covert XML documents to HTML or other document types, and XSL
114. XSL-FO. Acronym for Extensible Stylesheet Language Formatting Objects. An XML-based markup language for specifying formatting semantics. XSL-FO allows format and style information to be applied to an XML document and can be used with XSLT to produce source documents. See also XSL.
115. XSLT: Extensible Style sheet Language Transformations. A W3C recommendation for converting a document described with one set of markup into a document described by a different set of markup.
116. WELL-FORMEDNESS RULE: A syntactic constraint that all valid XML files must meet. XMI files and CWM XMI files, because they are also XML files, are subject to these constraints as well. Well-formedness constraints are specified in the definition of XML available from the Worldwide Web (W3C) consortium at www.w3c.org.

### GENERAL OVERVIEW

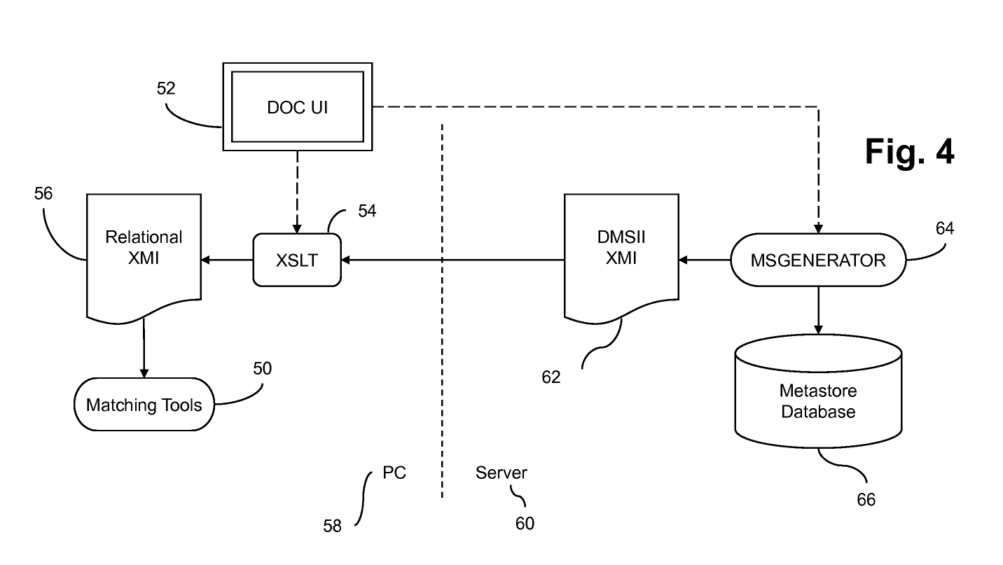

Now referring to FIG. 4 which indicates the various major elements involved in the present system and indicates the flow between the major elements. Thus in FIG. 4 there is seen the Database Operations Center User Interface 52 which requests a schema from MSGENERATOR 64. In this MSGENERATOR 64 is an ALGOL program that extracts a schema from a Metastore database 66 and generates a DASDL source file and also a XMI file which is based on the DMSII extended CWM-based model.

The Database Operations Center User Interface 52 then provides the XMI file to the XSLT 54 which is the Extensible Style Sheet Language Transformations. This is a W3C recommendation for converting a document described with one set of markup into a document which is described by a different set of markup.

The XSLT sees input from the DMSII XMI 62 which is a XMI document which follows the CWM standard and this is a document which describes a DMSII database. The module 62 also received input from the MSGENERATOR 64 which is an ALGOL program that extracts a schema from the Metastore 66 and then generates the DASDL source file and a XMI file.

The central dividing line in FIG. 4 shows a PC 58 which holds and supports the DOC UI 52, the XSLT 54, the Relational XMI 56 and the Modeling Tools 50.

Likewise the right hand side of FIG. 4 indicates the Server 60 which holds and supports the DMSII XMI 62 and the MSGENERATOR 64 and Metastore Database 66. The Metastore Database 66 is a DMSII database whose schema is generated from the DMSII extended CWM-based model. This database holds all the schemas of the DMSII databases of the system.

The XSLT Module 54 provides its output to form the Relational XMI 56. This is an XMI file which contains a description of components of a relational database schema. This information is then transformed into the Modeling Tools 50. These modeling tools are an industry-wide set of programming tools that allow for the creation, manipulation and processing of database schemas by using diagrams in a graphical user interface style.

Northwind is a common sample database provided by the Microsoft Corporation. It is an example of a relational database. “Open Tools” are third party products designed to model relational databases. The user will import their relational schema into one of these products. They can view, modify and save your schema. For example, the present system is currently using EMBARCADERO Tool that is a modeling tool enabling a user to create an XMI file representation of a relational model database.

In summary, a user or client will use the DOC UI 52 in order to obtain the DMSII schema. And then DOC UI 52 then directs the MSGENERATOR 64 to generate the DMSII XMI file 62 from the Metastore Database 66.

Then the DMSII XMI file 62 is file transferred from the Server 60 over to the PC 58.

The DOC UI 52 then applies a Style Sheet (XSLT) 54 from the DMSII XMI file 62 in order to transform it to a Relational XMI file 56. Then the Relational XMI file 56 is imported into the Modeling Tool 50 and thus the schema is presented to the user.

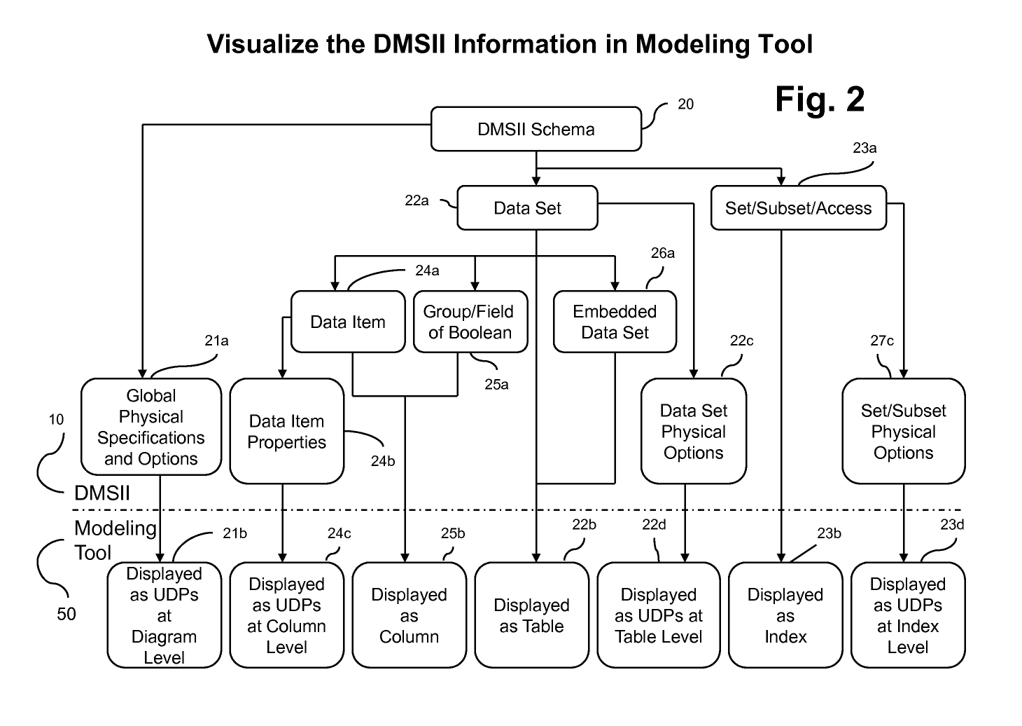

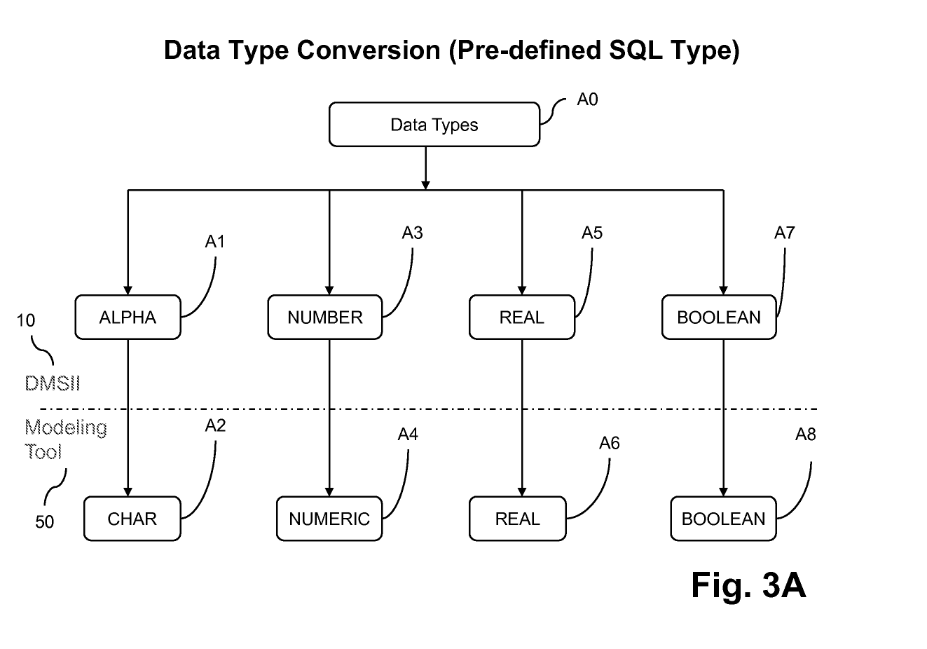

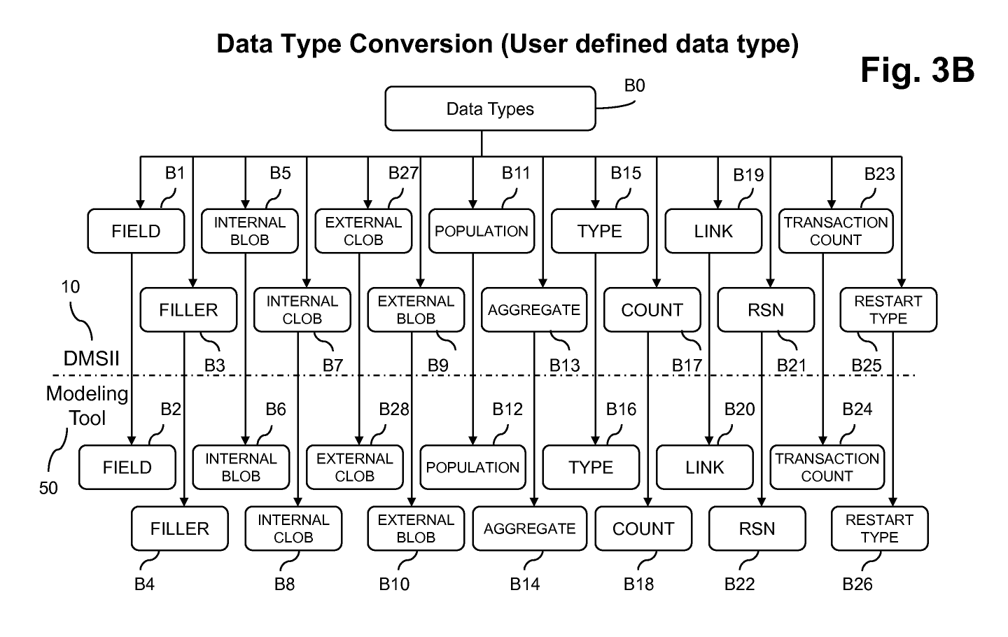

The conversion of items in FIGS. 2 and 3 are accomplished by a Stylesheet program to make the conversion from a DMSII item into a Modeling Tool item.

The Stylesheet program operates in the following sequence:

(i) Transform DMSII Database to Relational Diagram

(ii) Transform DMSII Datasets to Relational Tables

(iii) Transform DMSII Sets to Relational Indexes

(iv) Transform DMSII Data Items to Relational Columns

(v) Transform DMSII data types to Relational data types.

The XSLT Stylesheet takes a DMSII XMI file as input and produces an output Relational XMI file. The following examples show how some DMSII constructs (dataset, set) are translated into their Relational counterparts.

### 1. Dataset Example: DMSII Dataset is Translated to Class

### INPUT:

DMSII XMI file sample (input):
<CWMXDMSII.DataSet xmi.id=“_{—}563239” name=“BOOK”>
Style sheet (XSLT):

```
<xsl:template match=“CWMXDMSII.DataSet”>
  <xsl:element name=“modelElement”>
    <xsl:attribute name=“xsi:type”>mir:Class</xsl:attribute>
      <xsl:attribute name=“xmi:id”><xsl:value-of
select=“@xmi.id”/></xsl:attribute>
      <xsl:attribute name=“name”><xsl:value-of
select=“@name”/></xsl:attribute>
      <xsl:attribute name=“physicalName”><xsl:value-of
select=“@name”/></xsl:attribute>
  ...
</xsl:template>
```

### OUTPUT:

Relational XMI file sample (output):
<modelElement xsi:type=“mir:Class” xmi:id=“_{—}563239” name=“BOOK” physicalName=“BOOK”>

### 2. Set Example: DMSII Set is Translated to Index

### INPUT

DMSII XMI file sample (input):
<CWMXDMSII.Set xmi.id=“_{—}563256” name=“ORDERSNUMBER”>
Style sheet (XSLT):

```
<xsl:for-each select=“//CWMXDMSII.Set”>
  ...
    <xsl:variable name=“myIndex”>
      <xsl:call-template name=“genID”>
        <xsl:with-param name=“currVal” select=“substring-
    after(CWM.Index.indexedFeature/CWM.IndexedFeature/
    @xmi.id, ‘_’)”/>
      </xsl:call-template>
    </xsl:variable>
    <xsl:element name=“index”>
      <xsl:attribute name=“xsi:type”>mir:Index</xsl:attribute>
      <xsl:attribute name=“xmi:id”><xsl:value-of
    select=“$myIndex”/></xsl:attribute>
      <xsl:attribute name=“name<xsl:value-of select=“@name”/>
      </xsl:attribute>
  ...
</ xsl:for-each>
```

### OUTPUT:

Relational XMI file sample (output):
<index xsi:type=“mir:Index” xmi:id=“_{—}10563456” name=“ORDERSNUMBER”>

### DESCRIPTION OF A PREFERRED EMBODIMENT

Referring to FIGS. 3A and 3B there is seen a flowchart which provides data type conversion to enable both visualization and the editing of the Data Management System (DMSII) schemas in “modeling tools”. Conversion is a predefined Structured Query Language (SQL) type. Here the Unisys Mainframe Enterprise Server Database (DMSII) is a proven platform for use in mission critical applications.

As seen in FIG. 1 the sequence starts in order to enable the DMSII at step 10 whereby the Unisys Data Management System II provides a comprehensive primary database management software package that is in use on Unisys Clearpath families of mainframe computers.

The FIG. 1 indicates the design flow in steps, and shows the flow of activities that is used to “self-design” the project and to automate the code generation based on the model. Thus the steps from Start to End indicate the steps taken to model a DMSII schema into a relational modeling tool.

At step 20 (further delineated in FIG. 2) we have an action from Database to Model. This provides for converting structures, items, options, and properties in the DMSII schema into known structures, items, options, and properties in the “relational” schema model.

At step 30 there is a conversion of Data Type to Derived Type (which is further delineated in FIGS. 3A and 3B). In the conversion from DMSII Data Type to known Data Type, this is done to provide known Data Types in the relational schema model.

At step 40, indicated as Relational Schema Model, the final step is where a database schema of a relational database is now represented by an industry standard modeling XMI format such as the Common Warehouse Metamodel (CWM).

Regarding the Modeling Tool, these are third party programs that allow customers to build graphical models for database schemas. These tools enable converting the models into many industry standard formats such as the Common Warehouse Metamodel (CWM). One such modeling tool is the Embarcadero's ER/Studio. This is one such type of modeling tool with which the present invention has been developed around.

A database schema can be deployed in a Server environment such that the schema is usable by application programs. It should be noted however that periodically these schemas may undergo changes. These changes are affected in the schema and the database is then redeployed in order to reflect the changed database. This process and operation is called a “round trip life cycle of a schema”.

It should be noted that the DMSII is a hierarchical database and contains features that do not exist in a “relational” database. An example of such a feature is that of “embedded datasets”. Embedded datasets are similar to a table containing another table as a column. Such embedding is not permissible for relational database schemas.

Thus at step 40 of FIG. 1, there is a situation where the sequence provides for populating the modeling tools. This is done by importing a schema XMI into a modeling tool so that the schema can be graphically shown. It should be noted that there is an attachment feature of the modeling tool where the attachment is a piece of information that can be used to associate a diagram object selected such as a diagram, a table, an index or a column. This kind of attachment is also called a “User Defined Property” (UDP).

In summary of FIG. 1, the schema, as available in an XMI format, is used to populate the modeling tool. The attachment feature of the modeling tool can be used to add the hierarchical database artifacts into the modeling tool. And this allows for a viewable and editable view of the schema information.

Involved in this invention there are methods and processes for mapping and organizing this hierarchical schema information into the modeling tool visual representation. Further the edited information can be transferred back into the XMI file. This XMI file carries the edited information and then enables a “round trip life cycle” of the schema.

In order to “visualize” the DMSII information into a modeling tool, a series of steps is shown in FIG. 2. There are a number of items in the DMSII 10 in the upper portion of the drawing which are all items in the DMSII database.

Subsequently, a modeling tool is used by which these various items in the upper portion are now converted to items in the lower portion which are relational database items.

Referring to FIG. 2 and starting at the DMSII schema, 20, this then will isolate a dataset 22a and various dataset physical options 22c. These are then converted into the modeling tool so that the dataset 22a is now displayed as a table 22b. Likewise the dataset physical options 22c now become displayed as UDP at the Table level 22d. Here the UDP represents a User Defined Property which is an item defined with a property definition object.

Then for example, the DMSII schema, 20, then is selected to provide a Set/Subset/Access at 23a. Then at 27c it provides a Set/Subset physical options. As a result the Set Subset access 23a is converted into the modeling tool and displayed as an index at 23b. Likewise the Set Subset physical option of 27c will then become displayed in the modeling tool. This display is seen at 23d which is displayed as UDPs at the Table level.

Likewise starting at DMSII schema, 20, there is selected at 21a the Global Physical Specifications and Options of the DMSII 10. This is then converted by the modeling tool 50 to be displayed (at 21b) as UDPs at the Diagram Level.

These conversions from DMSII over to the modeling tool (ER/Studio) can be summarized as follows:

The Dataset 22a becomes the Table 22b. The Set/Subset/access 23a then becomes 23b displayed as Index.

The Data Item 24a then becomes a Displayed Column at 25b and Data Item Properties at 24b.

The Group/Field BOOLEAN item of 25a then becomes the Displayed as Column 25b in the Modeling Tool 50.

The Embedded Data Set 26a then becomes the Displayed as Table 22b in the Modeling Tool 50.

The Global Physical Specification and Options 21a then becomes Displayed as UDP at the Diagram Level at 21b.

The Dataset Physical Options 22c then becomes in the Modeling Tool a Displayed as UDP at Table Level 22d.

Then the Set/Subset Physical Options at 27c then becomes in the Modeling Tool a Displayed as UDP at the Index Level 23d.

Then the Data Item Properties 24b then becomes a Displayed as UDPs at Column Level 24c. As previously noted, the UDP is the User Defined Property. Regarding FIG. 2, there will be seen below some typical examples of items converted from the DMSII schema into the Modeling tool format.

### EXAMPLE: DMS SCHEMA 200F FIG. 2

```
$RESET DMCONTROL
INITIALIZE;
OPTIONS (
  AUDIT
  ,INDEPENDENTTRANS
  ,INTERNAL LOBS
  );
DEFAULTS (
    PACK = DMCP
  ,DATA SET (LOCK TO MODIFY DETAILS = TRUE)
  );
ORDERS DATA SET
    (ORDER-NUM NUMBER (8) REQUIRED;
    SHIPPERNAME ALPHA (25);
    ORDERDATE NUMBER (8);
    SHIPPEDDATE NUMBER (8);
    SHIPADDRESS ALPHA (50);
    FREIGHT-COST NUMBER (8,2);
    );
ORD-ORDERID-SET SET OF ORDERS KEY ORDER-NUM
      NO DUPLICATES, INDEX SEQUENTIAL;
RDS RESTART DATASET (RDS-DATA ALPHA (30));
```

### EXAMPLE: DATA SET 22 a of FIG. 2

```
ORDERS DATA SET
  (ORDER-NUM NUMBER (8) REQUIRED;
  SHIPPERNAME ALPHA (25);
  ORDERDATE NUMBER (8);
  SHIPPEDDATE NUMBER (8);
  SHIPADDRESS ALPHA (50);
  FREIGHT-COST NUMBER (8,2);
  );
```

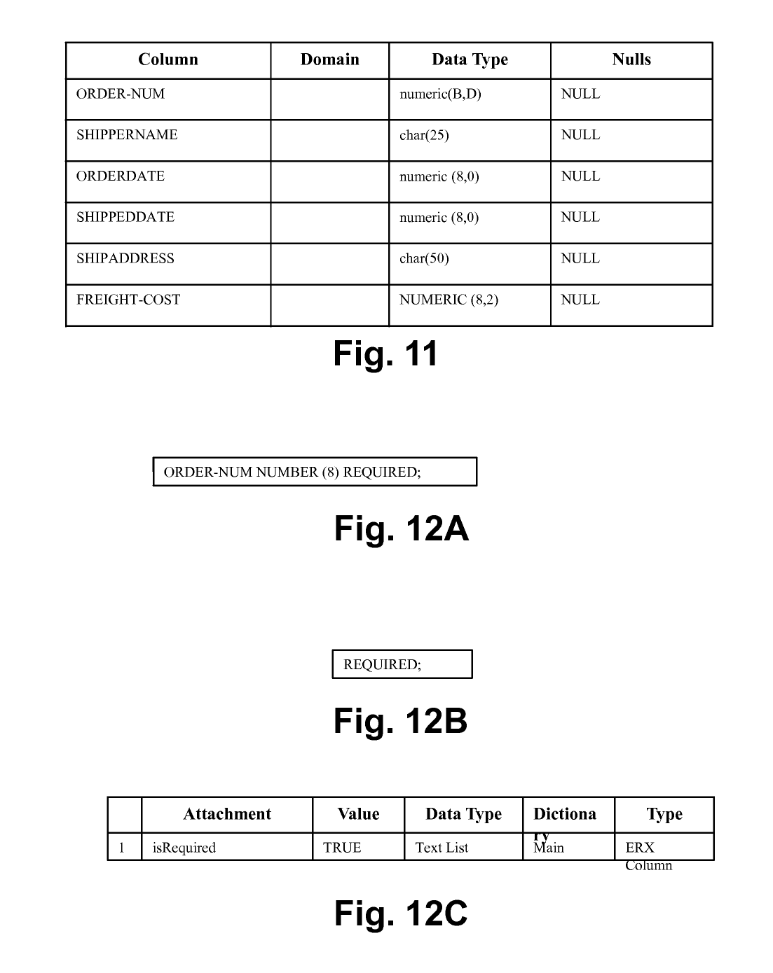

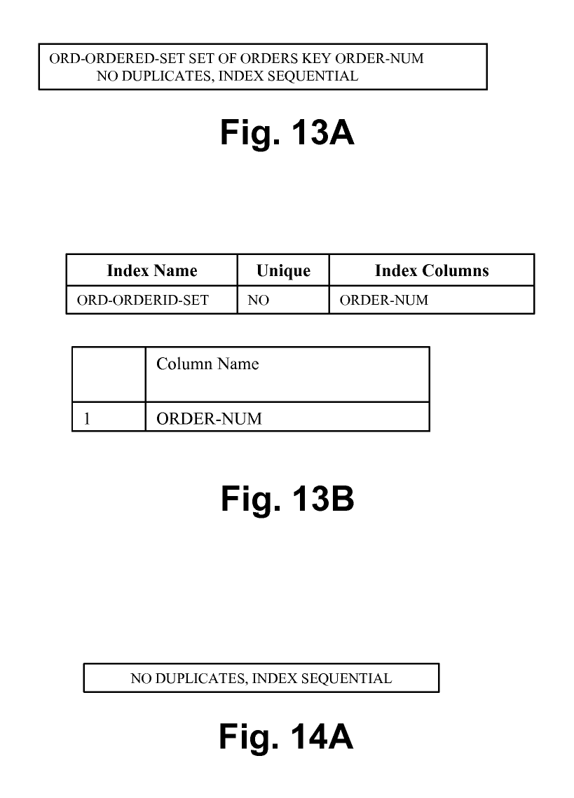

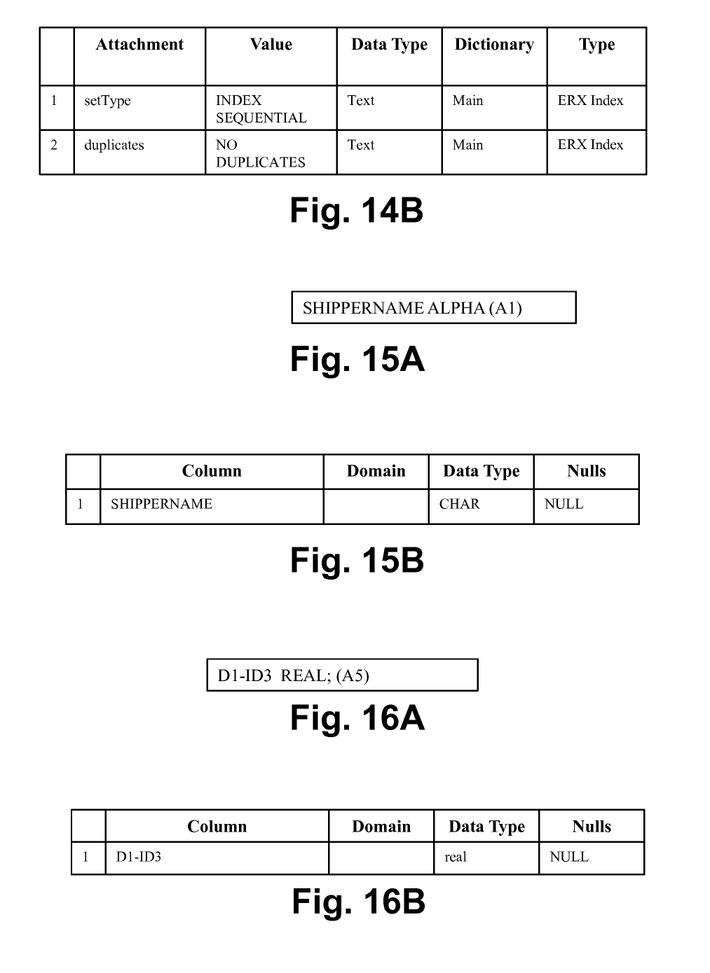

EXAMPLE: Relational Item at 22b of FIG. 2 is shown below:
Relational item at 22b is shown below displayed as a Table II in FIG. 11.:
Example: 24a of DMSII 10 is shown in FIG. 12A
Example: 24a of DMSII 10 is shown in FIG. 12A
Example: 24c of Modeling Tool (displayed as UDPs at Column Level is shown as FIG. 12C)
Example: 23a of DMSII 10 is shown in FIG. 13A then becomes the item of FIG. 13B
Example: 23b of Modeling Tool 50 shown in FIG. 13B
Example: 27c of DMSII 10 is seen in FIG. 14A then becomes displayed as UDPs at Index Level in FIG. 14B
Example: 23d of Modeling tool as shown below in FIG. 14B:

The Data Management System (DMSII) will be seen to have 18 defined data types. Among these data types, four of these as shown in FIG. 3A can be converted to known data types in the relational model. The remaining 14 data types are shown in FIG. 3B and are converted to User Defined Data Type (UDTs).

The base type for all generated UDTs is LONGVARCHAR. The type specific information is stored as attachments to the column which uses that particular UDT. For example, a column of the type LINK must declare a Link Structure and also a Link Type. And this extra information will be displayed as attachments to the column, as seen in Glossary Item #51.

Now referring to FIG. 3A there is illustrated a data type conversion for the predefined Structured Query Language type (SQL). The data types are shown at step Ao. From here there are four different types designated as ALPHA A1, NUMBER, A3, REAL, A5 and BOOLEAN, A7. These four data types reside in the database of the DMSII, 10.

Then each of these are converted into another representation as shown in the Modeling Tool 50.

Thus the ALPHA, A1 is converted to the character CHAR, A2 in the Modeling Tool 50.

Likewise the NUMBER type at A3 is converted to the NUMERIC at A4.

The REAL at A5 is converted to the REAL at A6 in the Modeling Tool 50.

Likewise, the BOOLEAN at A7 is converted to the BOOLEAN at A8 in the Modeling Tool 50. Examples follow:

In FIG. 3A: The conversion is seen in FIG. 15A to FIG. 15B
Shows DMSII “ALPHA” (A1) involves FIG. 15A which appears as Modeling Tool “CHAR” (A2) in FIG. 15B.
FIG. 3A Illustrates a DMSII “REAL” (A5) as seen in FIG. 16A which when converted becomes the item in FIG. 16B shown as Modeling Tool “REAL” (A6) as indicated in FIG. 16B.

Now referring to FIG. 3B there is illustrated the Data Type Conversion utilizing the User Defined Data Type (UDT).

Here the Data Types originate at B0. Then there are shown various different Data Types which occur in the database of the Data Management System 10. A dotted horizontal line then shows a new set of Data Types which will then appear as part of the Modeling Tool 50.

Thus in FIG. 3B there will be illustrated an initial item in the Data Management System and then there will be seen its counterpart in the Modeling Tool 50. Thus the FIELD B1 then becomes the FIELD B2 in the Modeling Tool 50. Likewise the FILLER B3 becomes the FILLER B4. Then the Internal BLOB, B5, becomes the Internal BLOB, item B6.

Then at item B7 the Internal CLOB is converted to a UDT defined as the Internal CLOB, B8 in Modeling Tool 50.

The DMSII type called External BLOB, B9 is converted to a UDT defined as External BLOB, B10.

DMSII type External CLOB, B27 is converted to a UDT defined as External CLOB, B28.

Likewise the DMS type AGGREGATE, B13 is converted to a UDT defined as AGGREGATE, B14. Then the DMS type POPULATION at B11 is converted to a UDT defined as POPULATION, at B12.

The DMS type COUNT at B17 is converted to a UDT defined as COUNT at B18.

The DMS “TYPE” at B15 is then converted to a UDT defined as TYPE at B16.

The DMS LINK at B19 is converted to a UDT defined as LINK at B20.

The DMS type designated as RSN at B21 is converted to a UDT defined as RSN at B22. RSN is the Record Serial Number.

The DMS type TRANSACTION COUNT at B23 is converted to a UDT defined as TRANSACTION COUNT at B24.

The DMS type RESTART TYPE at B25 is converted to a UDT defined as a RESTART TYPE at B26.

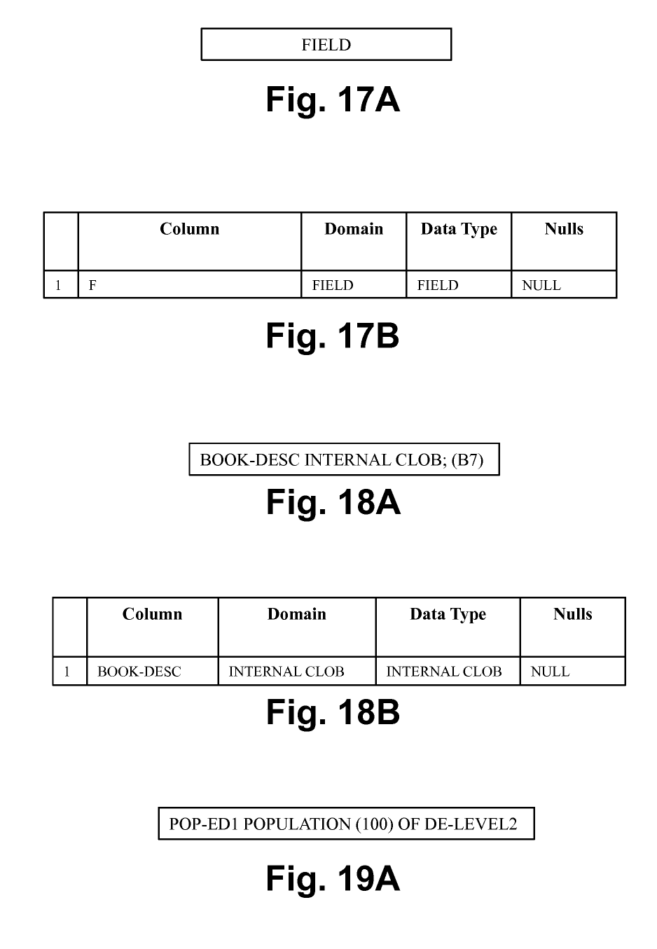

Presented below will be some actual examples of the visible representations involved where the conversion is made from the DMS 10 into the Modeling Ttool 50. These will be presented herein below in FIGS. 17, 18, 19, 20, and 21.

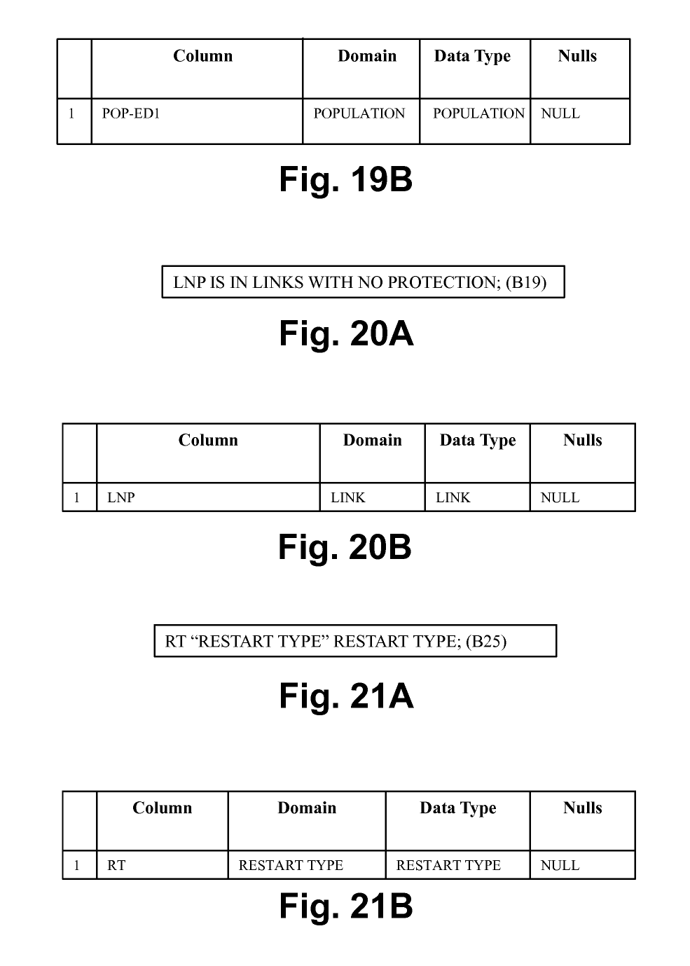

B1 in FIG. 3B is shown in FIG. 17A which is converted to FIG. 17B into B2 (FIELD) and is shown as in FIG. 17B.:
B7 in FIG. 3B is seen in FIG. 18A and is converted into B8 as indicated in FIG. 18B:
B11 of FIG. 3B is seen in FIG. 19A and is then converted into B12 as shown in FIG. 19B:
B19 (LINK) of FIG. 3B is seen in FIG. 20A and is converted into B20 as shown in FIG. 20B.
B25 in FIG. 3B (RESTART TYPE) is shown in FIG. 21A and is converted into B26 as shown in FIG. 21B.
RT “RESTART TYPE” RESTART TYPE; (B25) which is converted

In this way, the hierarchical schema items of a database of a Server can be transformed into Relational items by use of a Modeling Tool.

Described herein is the utilization of a Mainframe Enterprise Server Database (DMSII) which provides a Platform whereby hierarchical database artifacts are handled by an attachment feature with a stylesheet program of a modeling tool which will take hierarchical schemas and convert them into relational schemas. These relational schemas are viewable visually and then can easily be edited.

While one embodiment has been described, it should be understood that other variations may be configured but which still fall within the compass of the attached claims.

What is claimed is:

1. A method for utilizing a Modeling Tool to enable visualization and editing of a specialized schema in a hierarchical database which is converted to a relational schema using said Modeling Tool comprising the steps of:
(a) utilizing a server (60) with specialized Data Management System having a Metastore (66) to provide an XMI hierarchical file (62) from an MS Generator (64);
(b) forwarding said XMI file (62) to a PC (58) to apply an XSLT file (54) operating as an Extensible Style Sheet Language Transformation, said XSLT file (54) receiving input from a Database Operations Center User Interface (52) to develop a relational XMI schema (56);
(c) converting said relational schema (56) by use of a Modeling Tool (50) to provide visual indicia of said original hierarchical schema as a relational schema which can be seen in Table Format.

2. The method of claim 1 which includes the steps of:
(d) accessing said visual indicia at said relational schema to allow further editing.

3. In an apparatus having a Server (60) holding a Metastore Database (66) with hierarchical schema of data items, said Database being initiated by a (PC 58) using a Document Operations Center-User Interface (52) to generate a Relational XMI file (56) for transmittal to said PC (58) into an XSLT file (54) which forms a Relational XMI file (68) which can then be transformed via Modeling Tools (50) to visually show Relational schema items, a system for converting hierarchical schema items into relational representations of said schema items comprising:
(a) means to convert hierarchical schema items in a server database (66) to an XMI file (62);
(b) means, using an Extensible Style Sheet Language Transformation XSLT file (54), to convert said XMI file (62) into a relational XMI file (56);
(c) a Database Operations Center Interface (52) for initiating said XMI file for applying an XSLT file (54) to form said relational XMI file (56);
(d) relational XMI module means (56) for converting said XMI file (62) and applying an XSLT file (54) into relational schema items through use of a Modeling Tool 50;

4. In an apparatus having a Server (60) holding a Metastore Database (66) with hierarchical schema of data items, said Database being initiated by a PC (58) using a Database Operations Center-User Interface (52) to generate a DMSII XMI file (62) for transmittal to said PC (58) into an XSLT file (54) which forms a Relational XMI file (56) which can then be transformed via Modeling Tools (50) to visually show Relational schema items, a system for converting hierarchical schema items in a Metastore database (66) to representative Relational items via a Modeling Tool (50) comprising:
(a) a Metastore database (66) in a Server 60 holding schema items in hierarchical format;
(b) MSgenerator means (64) for converting said schema items into an DMSII XMI file (62);
(c) computer means (58) for receiving said DMSII XMI file (62) and converting said XMI file by applying an XSLT file (54) to said relational XMI file (56);
(d) converting means (62) for transforming said XMI file through an XSLT file (54) into a relational XMI file (56) for use by a Modeling Tool (50) to visually represent said schema items in relational format.

5. The system of claim 4 which includes:
(e) means to edit items converted by said Modeling Tool (50) for transfer back into said relational XMI file (56).

6. The system of claim 4 wherein said Modeling Tool (50) constitutes an Embarcadero ER/Studio program.

7. A computer readable medium incorporating a computer program including at least one instruction which when loaded on a computing system causes the computing system to perform the method steps in claim 3.
